(19) United States
(12) Patent Application Publication
(10) Pub. No.: US 2002/0116401 A1
(43) Pub. Date: Aug. 22, 2002

(54) Information management apparatus and method to organize information efficiently, recording medium recorded with information management program, and program product

(76) Inventors: Kiyotaka Kashito, Tenri-shi (JP); Hideyuki Otokawa, Yoshino-gun (JP)

Correspondence Address: BIRCH STEWART KOLASCH & BIRCH, PO BOX 747, FALLS CHURCH, VA, 22040-0747, US

(21) Appl. No.: 10/079,563

(22) Filed: Feb. 22, 2002

(30) Foreign Application Priority Data
Feb. 22, 2001 (JP) 2001-046757 (P)
Jan. 11, 2002 (JP) 2002-004492 (P)

(51) Int. Cl. G06F 12/00

(52) U.S. Cl. 707/200

(57) ABSTRACT

In an information data management apparatus, an available capacity for storage is ensured when information data is input and that information data is to be stored in a data storage unit. A process of reducing or compressing data is carried out on at least one of predetermined information data and summary data that indicates succinctly the contents of the predetermined information data. The predetermined information data and summary data are stored in correspondence in the data storage unit. The other data not subjected to reduction or compression remains in the data storage unit in the intact state. By presenting and confirming the other data left, the user can perceive the contents of corresponding information data succinctly when the other data is summary data. When the other data is information data, the details of the contents of the information data can be acquired.

### BACKGROUND OF THE INVENTION

1. Field of the Invention

The present invention relates to an information management apparatus, an information management method, a recording medium recorded with an information management program, and a program product. Particularly, the present invention relates to an information management apparatus and method to store and organize information efficiently even in the case where the medium into which information is to be stored is of small capacity, a recording medium recorded with an information management program, and a program product.

2. Description of the Background Art

Users can now obtain information of interest using information processing terminals with portable communication cap ability such as a portable cellular phone. The services providing such information include the recently-increasing PUSH type service in which the information transmission source provides a client with information at an arbitrary timing in addition to the so-called PULL type service in which a server responds to an information request from a client according to HTTP (Hyper-Text Transfer Protocol).

By means of the PUSH type service, information can be provided to the client immediately at a predetermined time or when information is generated at the information provider source even if the client does not transmit an information acquisition request. The provided information includes various types of information such as video and audio as well as text information, resulting in an increase in the information size.

The resource including a memory of the aforementioned conventional information terminal is limited in capacity due to its portability. The entire data that is to be received may not be stored in the memory if the amount of the data is too large. In the case where data is to be newly received when there is no more empty space in the incorporated memory, the reception is denied, or the data already stored in the incorporated memory is deleted partially or entirely according to a predetermined procedure depending upon each information terminal to allow storage of the newly received data in the empty region obtained as a result of delete.

In the case where the data is deleted in the order of, for example, the least recently received order according to the aforementioned data delete procedure, the oldest data will be deleted irrespective of whether the data is of importance or of interest to the user, or whether the content of the data has already been confirmed by the user. To solve this disadvantage, various approaches set forth below are afforded. “Receiver For Radio Calling” disclosed in Japanese Patent Laying-Open No. 9-224270 ensures a region to store new data by deleting the oldest message with the lowest priority.

“Selective Call Receiver And Message Storage/Delete Method” disclosed in Japanese Patent Laying-Open No. 9-238373 ensures a storage region for a new message by erasing the message with the lowest level of importance from the stored messages. Both of these approaches are disadvantageous in that a message, once deleted, cannot be confirmed thereafter since the entire message is deleted from the storage region.

In “Reception Data Management System” disclosed in Japanese Patent Laying-Open No. 11-196180, determination is made whether the received data has been confirmed by the user to define the data to be deleted or compressed in order to ensure a storage region for new data. However, the determination function is set in advance only at the system side. The user cannot set the parameter for determination. Although the received data includes two types of data differing in size, respective contents thereof can be set only at the system side.

In “Radio Transfer Apparatus Having Improved Operation During The Period Of Time When Network Is Available, And Transmission Method Thereof” disclosed in Japanese Patent Laying-Open No. 2000-148572, the channel resource is ensured by protecting the contents of a reserved cache memory from consolidation or refresh. However, protection is applied only on a reserved cache memory. Data stored in other cache memories will become the object of consolidation and refresh.

### SUMMARY OF THE INVENTION

An object of the present invention is to provide an information management apparatus and information management method that can confirm the contents of information that becomes the subject of reduction even if the information already stored is reduced for the purpose of ensuring a capacity for information storage, an information management method, a recording medium recorded with an information management program, and a program product.

Another object of the present invention is to provide an information management apparatus that can specify information that is to become the subject of reduction in a variable manner as desired, an information management method, a recording medium recorded with an information management program, and a program product.

According to an aspect of the present invention, an information management apparatus includes a data storage unit where various data is stored, and an output unit to present information including contents stored in the data storage unit. The information management apparatus includes an information data input unit to input information data, a summary data generation unit generating summary data that can indicate succinctly the contents of the information data input through the information data input unit, and a manager unit storing the information data input through the information data input unit and the summary data generated by the summary data generation unit in correspondence in the data storage unit.

The manager unit includes a data reduction unit. When the capacity of the information data input through the information data input unit and corresponding summary data is insufficient in the data storage unit, the data reduction unit reduces the data size of either predetermined information data or summary data stored in the data storage unit in correspondence until an available capacity for storage is ensured. At this stage, the predetermined information data and summary data is selected according to a criterion set in a variable manner.

Since the predetermined information data and summary data that is to become the subject of data reduction can be selected according to a criterion set in a variable manner, the data that is the subject of reduction can be selected according to the user's demand. Thus, the usability is improved.

Since the amount of data for at least one of predetermined information data and summary data stored in correspondence with each other is reduced in ensuring an empty region to store input information data into the data storage unit, the other data not subject to reduction remains in the data storage unit intact. By presenting and confirming the other data at the output unit, the contents of the corresponding information data can be confirmed succinctly in the case where the other data is summary data. In the case where the other data is information data, the contents can be identified in detail.

The information management apparatus can apply a restore process to result in the original data amount in order to present the predetermined information or predetermined summary data subjected to data reduction via the output unit.

Since a restore process is carried out to result in the original data amount when the predetermined information data or summary data that is subjected to data reduction is to be presented and confirmed via the output unit, the contents in a state prior to reduction can be confirmed.

The data reduction unit in the information management apparatus of the present aspect can reduce in stages the amount of data of at least one of predetermined information data and summary data until a capacity available for storage is ensured. This data reduction carried out in a stepped manner until an available capacity for storage is ensured avoids the problem that more data than needed is reduced.

In the information management apparatus of the present aspect, summary data may indicate a portion of the contents of the information data. Also, summary data may indicate the feature of the information data. By presenting and confirming summary data at the output unit, the contents or feature of information data corresponding to the summary data can be perceived.

In the information management apparatus of the present application, data reduction can be effected by deleting at least one of the predetermined information data and summary data from the data storage unit.

Since at least either the predetermined information data or summary data already stored is deleted when information data is input and is to be stored in the data storage unit, an empty region sufficient for storage can be obtained promptly.

In the information management apparatus of the present aspect, data reduction can be effected by compressing at least one of predetermined information data and summary data in the data storage unit.

When input information data is to be stored in the data storage unit, at least either the predetermined information data or summary data already stored can be compressed to ensure an empty region. In this case, the aforementioned restore process is a decompress process of compressed data.

In the case where the available capacity for storage is still insufficient even if all the predetermined information and summary data in the data storage unit are compressed in the information management apparatus of the present aspect, at least one of predetermined information data and summary data stored in correspondence in the data storage unit can be deleted until an available capacity for storage is ensured.

In the case where all the data stored in the data storage unit are compressed, further available capacity can be ensured by deleting at least one of the predetermined image data and summary data.

In the information management apparatus of the present aspect, deletion of at least one of the predetermined information data and summary data can be carried out stepwise until an available capacity for storage is ensured. This prevents data from being deleted excessively.

The information management apparatus of the present aspect can include an importance level determination unit to determine the level of importance of information data corresponding to summary data based on a predetermined guideline that is set in a variable manner. The criterion can correspond to the level of importance determined by the importance level determination unit.

The predetermined information data or summary data that becomes the subject of reduction (deletion or compression) can be determined based on a corresponding level of importance.

The level of importance is determined based on a predetermined guideline that is set in a variable manner. The user can set a predetermined guideline in a variable manner to alter the importance to a desired level. As a result, the predetermined information data or predetermined summary data that becomes the subject of reduction (deletion or compression) can be set as desired by the user.

The information management apparatus of the present invention further includes a guideline set unit that is operated by an external source to set a predetermined guideline in a variable manner. In setting a predetermined guideline in a variable manner, the user only has to operate the guideline set unit from an external source.

The level of importance corresponding to the predetermined information data and summary data is lower than the level of importance of the newly input information data. Therefore, data having a level of importance lower than that of the newly input information data can be set as more likely to be chosen for reduction.

In the information management apparatus of the present aspect, the manager unit includes an insufficient capacity determination unit. The insufficient capacity determination unit compares the available capacity in the data storage unit with the total size of the information data newly input by the information data input unit and corresponding summary data to determine insufficient capacity based on the comparison result.

The summary data generation unit in the information management apparatus of the present aspect generates summary data from the contents of information data based on data obtained according to a predetermined condition. The predetermined condition is set in a variable manner.

By setting the predetermined condition in a variable manner, the contents of the summary data can be altered as desired by the user. For example, the user can alter the setting so that only information of higher requirement is included in the summary data.

The information management apparatus of the present aspect further includes a condition set unit operated by an external source to set a predetermined condition in a variable manner. In setting a predetermined condition in a variable manner, the user only has to operate the condition set unit from an external source.

When an available capacity is to be ensured in storing input information data into the data storage unit, compression is effected on at least one of predetermined summary data and predetermined information data stored in correspondence. Therefore, the other data not subjected to compression can be left in the data storage unit in the intact format. By presenting and confirming the other data at the output unit, the contents of the corresponding information data can be perceived succinctly when the other data is summary data. When the other data is information data, the contents of the information data can be perceived in detail.

In order to present the compressed information via the output unit in the information management apparatus of the present aspect, a decompression process is effected on the relevant information. In the case where the compressed predetermined information data or summary data is to be presented and confirmed via the output unit, the contents can be perceived in detail since the decompression process is carried out to obtain the original data.

The compression unit of the information management apparatus of the present aspect can compress the data amount of at least one of predetermined information data and summary data in a stepped manner. Since the available capacity for storage can be ensured while carrying out compression stepwise, excessive compression can be avoided.

According to another aspect of the present invention, an information management method includes an information data input step of entering information data, a summary data generation step of generating summary data that can indicate the contents of the input information data succinctly, and an organization step of storing, in correspondence, information data input at the information data input step and summary data generated at the summary data generation step into a data storage unit prepared in advance having stored contents presented via an output unit prepared in advance. The organization step includes a data reduction step. In the case where the data storage unit lacks sufficient capacity to store information data newly input through the information data input step and corresponding summary data, the data of at least one of predetermined information data and summary data stored in correspondence in the data storage unit is reduced until available capacity for storage is ensured in the data reduction step. In the present aspect, the predetermined information data and summary data are selected according to a criterion set in a variable manner.

Since the predetermined information data and summary data that is to become the subject of reduction is selected according to a criterion set in a variable manner, the subject of data reduction can be selected as desired by the user. Thus, the usability is improved.

In the case where an available capacity is to be ensured in storing input information data into the data storage unit, the data of at least one of predetermined summary data and predetermined information data stored in correspondence is reduced. Therefore, the other data not subjected to reduction can be left in the data storage unit in the intact state. By presenting and confirming that other data at the output unit, the contents of the corresponding information data can be perceived succinctly when the other data is summary data. When the other data is information data, the contents thereof can be perceived in detail.

According to a further aspect of the present invention, an information management method includes an information data input step of entering information data, a summary data generation step of generating summary data that can indicate succinctly the contents of information data input through the information data input step, and an organization step of storing, in correspondence, information data input at the information data input step and summary data generated at the summary data generation step in a data storage unit prepared in advance, having the stored contents presented via an output unit prepared in advance. The organization step includes a compression step. In the case where the capacity to store the information data newly input at the information data input step and corresponding summary data is insufficient in the data storage unit, at least one of the predetermined information data and summary data stored in correspondence in the data storage unit is compressed until an available capacity for storage is ensured at the compression step. In the present aspect, the predetermined information data and summary data are selected according to a criterion set in a variable manner.

Since the predetermined information data and summary data that becomes the subject of compression can be selected according to a criterion set in a variable manner, the data of interest of compression can be selected as desired by the user. Thus, the usability is improved.

In the case where an available capacity is to be ensured in storing input information data in the data storage unit, compression is effected on at least one of the predetermined summary data and predetermined information data stored in correspondence. Therefore, the other data not subjected to compression can be left in the data storage unit in the intact format. By presenting and confirming that other data at the output unit, the contents of the corresponding information data can be perceived succinctly when the other data is summary data. When the other data is information data, the contents of the information data can be perceived in detail.

According to still another aspect of the present invention, a recording medium is machine-readable. An information management program to execute the above-described information management method through the machine is recorded in the recording medium.

According to a still further aspect of the present invention, a program product executes the above-described information management method through a computer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an information data management apparatus according to a first embodiment of the present invention.

FIG. 2 is a flow chart of an information data acquisition process in the information data management apparatus of FIG. 1.

FIG. 3 shows a specific example of summary data extracted by the summary data extraction unit of FIG. 1.

FIG. 4 is a flow chart of an importance level determination process according to the first embodiment.

FIG. 5 is a flow chart of a storing process of summary data, information data, and importance level data according to the first embodiment.

FIG. 6 shows an example of a screen displayed to set the importance level according to the first embodiment.

FIG. 7 shows an example of summary data extracted when the information data is electronic mail data in the first embodiment.

FIG. 8 shows the case where information data is electronic mail data with an attached file in the first embodiment.

FIG. 9 shows an example of a screen notifying the user of data deletion in the first embodiment.

FIG. 10 shows an example of a screen to prompt the user to confirm data deletion in the first embodiment.

FIG. 11 shows a structure of an information data management apparatus according to a second embodiment of the present invention.

FIG. 12 is a flow chart of an information data acquisition process of the second embodiment.

FIG. 13 is a flow chart of an information data confirmation process of the second embodiment.

FIG. 14 shows an appearance of an information processor according to a third embodiment of the present invention.

FIG. 15 shows a structure of the function of the information processor of FIG. 14.

### DESCRIPTION OF THE PREFERRED EMBODIMENTS

Embodiments of the present invention will be described hereinafter with reference to the drawings.

First Embodiment

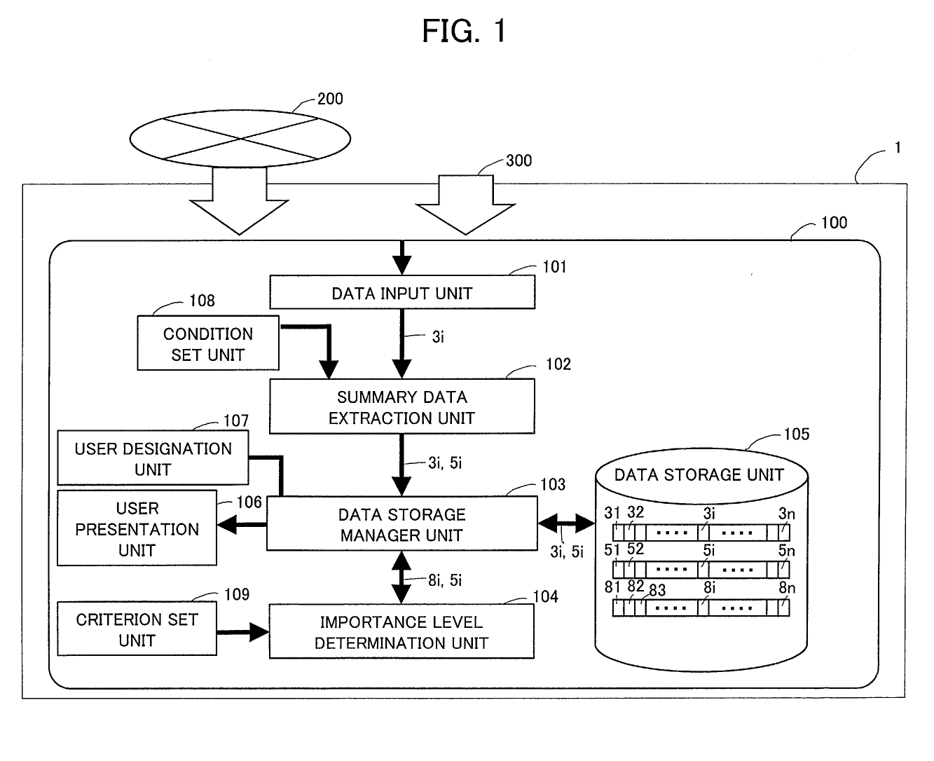

A first embodiment of the present invention will be described based on an information data management apparatus 100. FIG. 1 is a block diagram of information data management apparatus 100. Information data management apparatus 100 is incorporated in an information processor 1 having communication capability with an external source and information processing capability via the Internet 200. Information data management apparatus 100 includes a data input unit 101, a summary data extraction unit 102, a data storage manager unit 103, an importance level determination unit 104, a data storage unit 105, a user presentation unit 106, a user designation unit 107, a condition set unit 108 and a criterion set unit 109.

Data input unit 101 includes a data input capability. According to the data input capability, applied data is input, and then output as information data 3i (i=1, 2, 3, . . . , n). Applied data includes, but not limited to, data received at information processor 1 through Internet 200, and data applied through a user input 300 corresponding to an operation to input data using, for example, a keyboard not shown of information processor 1.

Summary data extraction unit 102 has the extraction capability to enter information data 3i output from data input unit 101 to extract summary data 5i (i=1, 2, 3, . . . , n) from information data 3i.

Data storage unit 105 is a memory of a type in which information of a plurality of types is stored. Data storage unit 105 has information data 3i, summary data 5i and importance level data 8i that will be described afterwards stored in correspondence with each other.

User presentation unit 106 has the capability to present user with information via an output unit that has the capability to output information by, for example, display or print out or audio, of information processor 1. When information read out from data storage unit 105 is input, user presentation unit 106 outputs the input information via the output unit to present the user with the input information.

User designation unit 107 enters instructions and requests applied by the user through a keyboard or the like of information processor 1. User designation unit 107 outputs a request to browse specific information data 3i or summary data 5i in data storage unit 105, when such a request is input, to data storage manager unit 103.

Data storage manager unit 103 has the capability to administer the available capacity of data storage unit 105, the capability to delete data, the capability to store information data 3i and summary data 5i in correspondence in data storage unit 105, and the capability to read out and output to user presentation unit 106 desired information from data storage unit 105 in response to a request from user designation unit 107.

Importance level determination unit 104 determines the level of importance of corresponding information data 3i based on applied summary data 5i to output importance level data 8i according to the determination result.

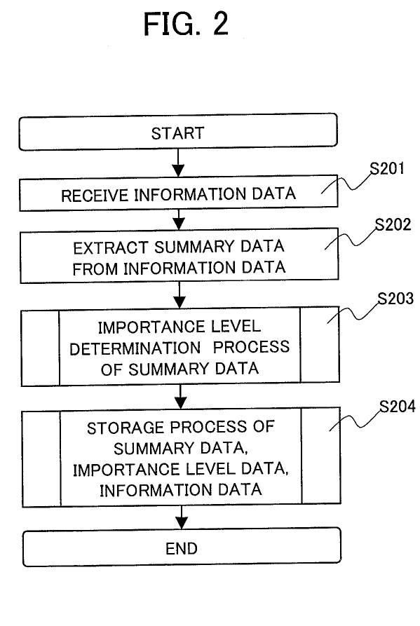

FIG. 2 is a flow chart of an information data acquisition process in information data management apparatus 100 shown in FIG. 1. The process when information data 3i is input to information data management apparatus 100 of FIG. 1 will be described with reference to the flow chart of FIG. 2.

Externally applied data is input by data input unit 101, and output to summary data extraction unit 102 as information data 3i. Summary data extraction unit 102 receives information data 3i to extract summary data 5i from received information data 3i (step S201 (step abbreviated to S hereinafter) and S202). Extracted summary data 5i and corresponding information data 3i are applied to data storage manager unit 103. Data storage manager unit 103 receives the applied summary data 5i and information data 3i, and outputs received summary data 5i to importance level determination unit 104.

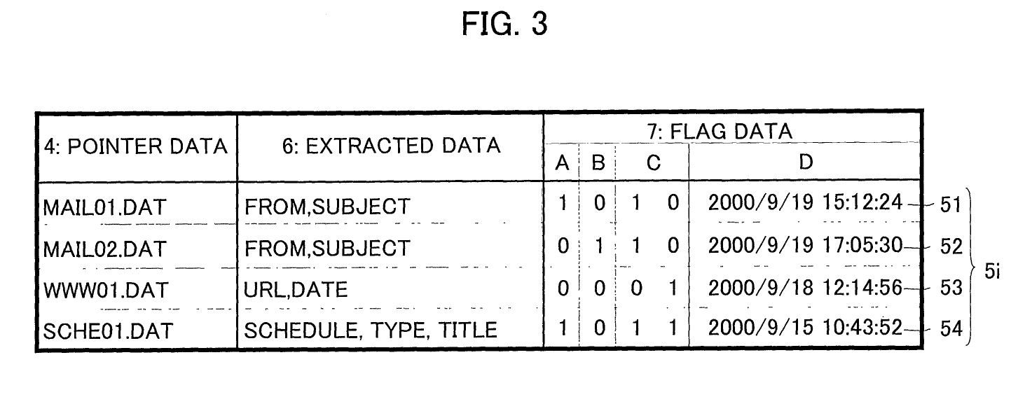

FIG. 3 shows a specific example of summary data 5i extracted by summary data extraction unit 102 of FIG. 1. Summary data 5i includes a portion of corresponding information data 3i or data representing a feature of corresponding information data 3i, and can indicate the contents of corresponding information data 3i succinctly. The amount of data of summary data 5i is smaller than that of corresponding information data 3i. Summary data 5i includes pointer data 4, extracted data 6 and flag data 7. Pointer data 4 is the information to specify and designate corresponding information data 3i. Extracted data 6 indicates the data per se extracted from corresponding information data 3i. Flag data 7 includes at least one flag, referred to by importance level determination unit 104 to determine the level of importance of corresponding information data 3i. The user can perceive the contents of summary data 5i via user presentation unit 106. Here, four summary data 51-54 are exemplified.

In the case where corresponding information data 3i is data stored in a file, pointer data 4 indicates the file name thereof. When corresponding information data 3i is stored in data storage unit 105, pointer data 4 can use a pointer to designate information data 3i in data storage unit 105.

By utilizing the format of corresponding information data 3i, extracted data 6 indicates contents extracted from the relevant information data 3i. In the case where corresponding information data 3i is electronic mail, a From field indicating the information of the transmission source of the relevant electronic mail or a Reply-To Field indicating information of an address or a Subject field indicating the subject of the mail is extracted and set as extracted data 6. In the case where From field is extracted, the party to send a reply for corresponding information data 3i (electronic mail) can be inferred by referring to summary data 5i. In the case where Subject field is extracted, the contents of the body of corresponding information data 3i (electronic mail) can be estimated by referring to summary data 5i.

Thus, even in the case where information data 3i is deleted from data storage unit 105 and only summary data 5i can be reviewed, presentation of a From field and a Subject field in extracted data 6 in summary data 5i, in the case of mail, allows the user to at least confirm the dispatcher and subject of the mail. Summary data 5i can be used for presentation to the user as well as in other processes in information data management apparatus 100. For example, determination of an importance level that will be described afterwards can be made using flag data 7 in summary data 5i.

In the case where corresponding information data 3i is Web data, URL (Uniform Resource Locator) data is extracted from the relevant information data 3i and set as extracted data 6. Therefore, the corresponding information data 3i (web data) can be accessed again based on the URL data obtained by referring to summary data 5i.

In the present example, flag data 7 includes flags A, B, C and D. The value of flag A indicates whether protection on deletion of corresponding information data 3i is to be set or not. Flag A takes value 1 when protection is set and value 0 when protection is not set. The value of flag B indicates whether corresponding information data 3i has not yet been referred to by the user, or already referred to by the user. Flag B takes the value of 1 when corresponding information data 3i is not yet referred and the value of 0 when already referred. Flag C indicates the type of corresponding information data 3i by a value of 2 bits. Flag C takes the value of 11 when information data 3i indicates the schedule, the value of 10 when information data 3i is electronic mail, the value of 01 when information data 3i is web data, and the value of 00 for other cases. Flag D indicates the date of receiving corresponding information data 3i via the Internet 200, or the date input by user input 300, or a date of update. By handling the type of information data 3i in a manner similar to those of other items, the level of importance (priority) referred to for determination of deletion can be set arbitrarily based on the data type, as will be described afterwards.

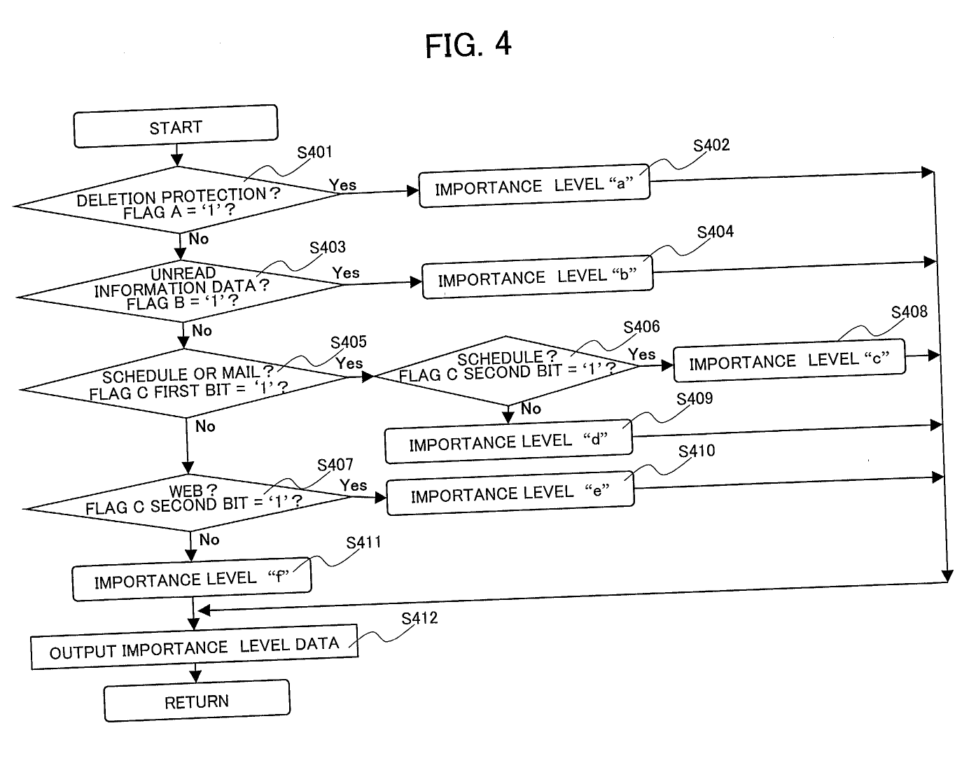

Referring to FIG. 2 again, importance level determination unit 104 receives summary data 5i and refers to flag data 7 in received summary data 5i to execute an importance level determination process set forth below according to the flow chart of FIG. 4.

First, determination is made whether 1 is set in flag A in the input summary data 5i (S401). In the case where flag A takes the value of 1, “a” is set in corresponding importance level data 8i since corresponding information data 3i is protected data designated by the user so as not to be deleted (S402). In the case where flag A takes the value of 0, control proceeds to identify the value of flag B (S403). In the case where flag B takes the value of 1, “b” is set in corresponding importance level data 8i since corresponding information data 3i is information not yet read (S404). In the case where flag B takes the value of 0, control proceeds to identify control proceeds to identify the value of flag C (S405-407).

In the case where flag C takes the value of 11, “c” is set in corresponding importance level data 8i since corresponding information data 3i is schedule data (S408). In the case where flag C takes the value of 10, “d” is set in corresponding importance level data 8i since corresponding information data 3i is electronic mail data (S409). In the case where flag C takes the value of 01, “e” is set in corresponding importance level data 8i since corresponding information data 3i is Web data (S410). In the case where flag C takes the value of 00, “f” is set in corresponding importance level data 8i since corresponding information data 3i is other data (S411).

Importance level data 8i having respective values set as described above is output to data storage manager unit 103 (S412). Thus, the importance level determination process ends.

The level of importance of information data 3i becomes lower in the order of value a, b, c, d, e and f of importance level data 8i. When there are a plurality of information data 3i having the same value for importance level data 8i, the level of importance is determined based on the reception date or input date or update date indicated by corresponding flag D. In other words, a lower level of importance is defined for information data 3i in proportion to an older least recent) reception date or input date or update date.

A lower level of importance in importance level data 8i for information data 3i has been set in the order of schedule data, electronic mail data, Web data, and other data. However, the setting order is not limited thereto. For example, a determination method of the level of importance can be implemented so that a certain electronic mail, for example, that has importance level data 8i higher than the schedule data or lower than Web data is included.

As an alternative to the importance level determination through importance level determination unit 104, the user can directly determine and specify the level of importance.

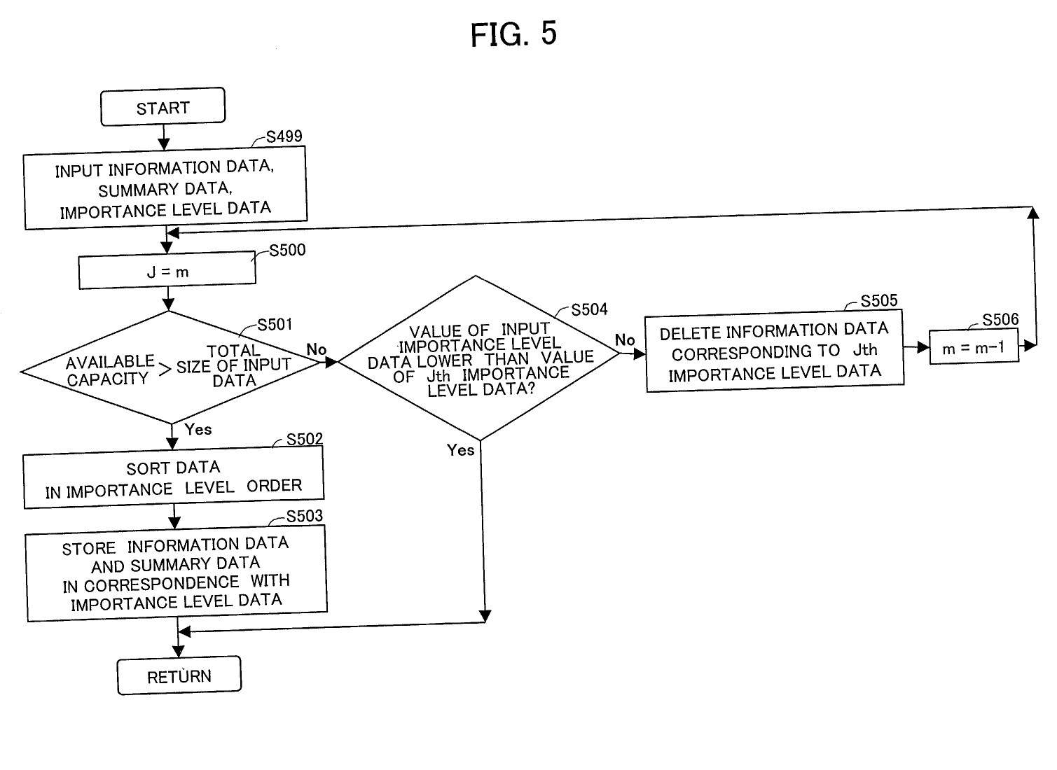

Referring to FIG. 2 again, following the above-described importance level determination process, data storage manager unit 103 executes a storing process to set summary data 5i, information data 3i and importance level data 8i in correspondence (S204). The storing process of summary data 5i, information data 3i and importance level data 8i will be described according to the flow chart of FIG. 5. It is assumed that information data 3i and summary data 5i and importance level data 8i corresponding thereto are stored, ‘m’ each, in data storage unit 105.

Data storage manager unit 103 inputs summary data 5i and corresponding information data 3i from summary data extraction unit 102 and also importance level data 8i corresponding to the input information data 3i from importance level determination unit 104 (S499). Value ‘m’ is set to the control variable ‘J’ of the process (S500) The total size of the input information data 3i and summary data 5i is compared with the available capacity in data storage unit 105 (S501).

In the case where the comparison result indicates that the total size of the input information data 3i and summary data 5i is smaller than the available capacity in data storage unit 105, the input importance level data 8i is sorted and stored in data storage unit 105 in the order of the plurality of importance level data 8i stored in data storage unit 105. Then, the input information data 3i and summary data 5i are stored in data storage unit 105 in correspondence with the sorted importance level data 8i (S502 and S503). Thus, the process ends.

In the case where the total size of the input information data 3i and summary data 5i is greater than the available capacity in data storage unit 105, determination is made whether the value of the input importance level data 8i is lower than the value of the Jth importance level data 8i stored in data storage unit 105 (S504).

When the determination result indicates that the value of the input importance level data 8i is lower, the input information data 3i, summary data 5i and importance level data 8i will not be stored in data storage unit 105, and the process ends. In contrast, when the value of the Jth importance level data 8i stored in data storage unit 105 is lower, information data 3i corresponding to that Jth importance level data 8i is deleted from data storage unit 105 (S505). Following this deletion of one information data 3i, the value of m is updated to m=m−1 (S506). Control returns to S501, and the subsequent process is repeated until the input information data 3i and summary data 5i are stored in data storage unit 105. Then, the process by data storage manager unit 103 ends.

In the present first embodiment, deletion of information data 3i from data storage unit 105 is executed in order to ensure a region in data storage unit 105 to store the newly input data. However, since summary data 5i corresponding to the deleted information data 3i still retains in data storage unit 105, the contents indicating the deleted information data 3i succinctly (pointer data 4, extracted data 6 and flag data 7) can be perceived by referring to the relevant summary data 5i. Accordingly, the contents of relevant information data 3i can be inferred.

Although the subject of deletion is information data 3i here, corresponding summary data 5i can be deleted instead.

In the case where the data to infer the contents of the deleted information data 3i is not required, information data 3i and corresponding summary data 5i can be deleted simultaneously instead of deleting only information data 3i as in FIG. 5. Such deletion designation can be specified at the user side via user designation unit 107.

The data to be deleted does not necessarily have to be determined according to the determination process based on importance level data 8i. For example, information data 3i corresponding to electronic mail from a certain mail address can be deleted with priority. Such a designation can be carried out at the user side via user designation unit 107.

Also, the present embodiment can be implemented in which summary data 5i is generally not stored. Only in the case where the available capacity in data storage unit 105 is insufficient, summary data 5i is extracted for determination of the level of importance.

The types of flags included in flag data 7 of summary data 5i is not limited to those described above. A flag that indicates the dispatch source of corresponding information data 3i or a flag indicating whether a particular text train is included or not can be employed. Also, the type of flag set depending upon the type of information data 3i can be altered. Furthermore, by allowing the user who is using information data management apparatus 100 to set the value of importance level data 8i and the flag, data management that is more conformable to the user's request can be implemented. Such a user request can be designated by the user via a criterion set unit 109.

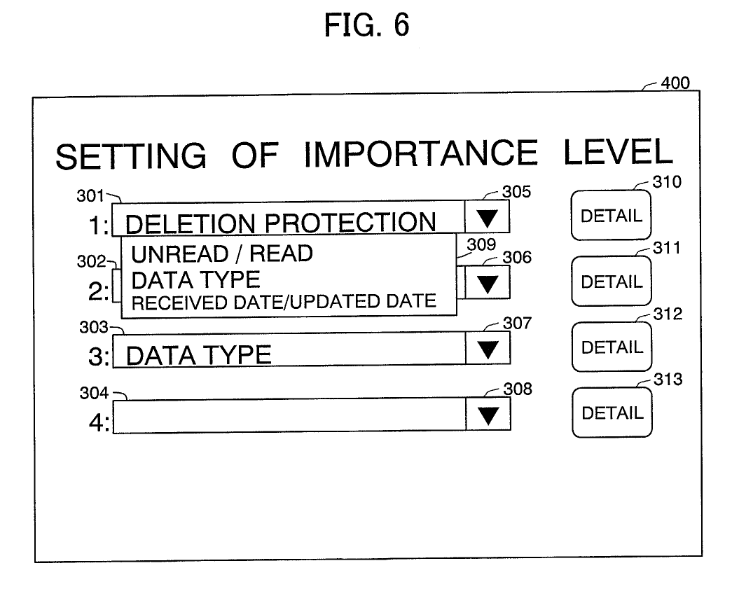

Accordingly, the level of importance can be altered as desired by the user. For example, the user who wishes to have mail data saved above all can raise the priority of flag C through the setting using, for example, a screen 400 shown in FIG. 6 directed to importance level setting. The user who merely wishes to delete data from the oldest data can raise the priority of flag D.

An example of a screen displayed via the output unit of information processor 1 to set importance level data 8i (priority) as to the four determination criteria corresponding to the aforementioned flags A, B, C and D in information data processor 1 is shown in FIG. 6. The four determination criteria include the items of “deletion protection” 314, “unread/read” 315, “data type” 316, and “received date•updated date” 317. In screen 400 of FIG. 6 for information data 3i, list buttons 305, 306, 307, 308 and buttons 310, 311, 312, 313 corresponding to display areas 301, 302, 303, 304, respectively, to display a desired determination criterion specified by the user are provided. Here, the level of importance priority) for the determination criterion displayed in each of display areas 301, 302, 303 and 304, in order, is determined.

The user operates respective list buttons 305, 306, 307 and 308 to display, in a list format, the labels of the four determination criteria relating to corresponding display areas 301, 302, 303 and 304, respectively. FIG. 6 corresponds to the case where list button 305 is operated to display determination criterion list 309. The user specifies the desired type of determination criterion from the displayed determination criterion list, whereby the specified determination criterion is displayed on the corresponding display area. In FIG. 6, deletion protection 314 is specified as the determination criterion from the determination criterion list 309, i.e. as the determination criterion desired by the user to be set with the highest level of importance. Thus, the desired determination criterion selectively specified from determination criterion list 309 displayed by operating respective list buttons 305-308 is displayed in respective display areas 301304 is provided.

Buttons 310-313 function to display a screen for setting (not shown), when operated, in the case where a criterion to set the level of importance in further detail for the determination criterion displayed in each of corresponding display areas 301-304. For example, when “data type” 316 is displayed in display area 303, an operation on button 312 causes display of a screen to set in further detail the level of importance based on the data type such as electronic mail, Web data, schedule data and the like. In the case where, for example, “received date•updated date” 317 is displayed in display area 303, an operation on button 312 causes display of a screen to set in further detail the level of importance based on the ascending/order/descending order of the received date.

The determination criterion to set the level of importance is not limited to that described above. A complicated structure such as a tree structure can be implemented. Furthermore, particular data can be specified by a combination of a plurality of conditions.

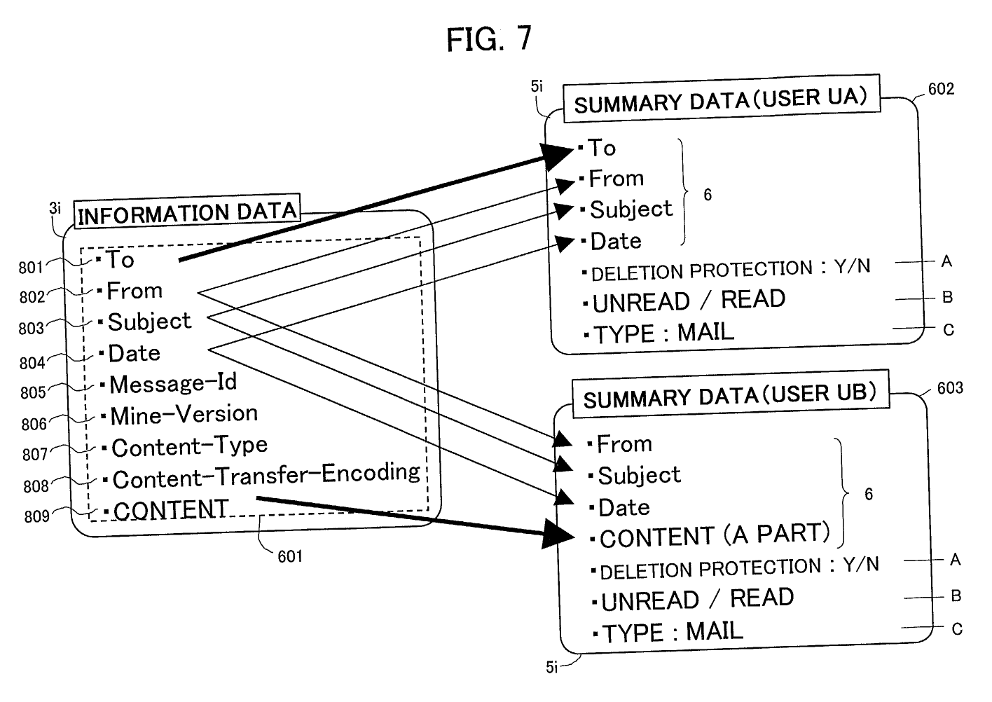

FIG. 7 shows an example of summary data Si extracted when information data 3i is electronic data. Since electronic mail is transferred to the mail address mainly used by information data management apparatus 100 from a plurality of mail addresses here, it is assumed that there are present a user UA who requires a “To field” indicating the address of the electronic mail, and a user UB who requires the contents of the body of the electronic mail to look into the contents per se.

It is assumed that a mail body 601 corresponding to information data 3i includes a To field 801 indicating the information of destination, a From field 802 indicating information of the dispatcher, a Subject field 803 indicating the subject of the mail, a Date field 804 indicating the date of transmission, a Message-ID field 805 indicating a message ID, a Mine-Version field 806, a Content-Type field 807 indicating the mail format, a Content-Transfer-Encoding field 806 indicating the character code of the mail, and a mail main text 809. Summary data extraction unit 102 extracts summary data 602 and 603 including extracted data 6 as summary data 5i from mail body 601 in response to the request of users UA and UB, respectively.

Summary data 602 and 603 include Date field 804, From field 802 and Subject field 806 in common to extracted data 6. The field included in summary data 602 as extracted data 6 unique to user UA includes To field 801. The field included in summary data 603 as extracted data 6 unique to user UB includes mail text (partial) 810 which is a portion of mail main text 809. This mail main text (partial) 810 may be just the several ten to several hundred characters from the beginning of mail main text 809, or a summary of mail main text arranged by some means indicating the feature of the described contents in mail main text 809.

In the present embodiment, data of less importance to newly input data for storage into data storage unit 105 is deleted from data storage unit 105. An application set forth below is also allowed. The data deleted from data storage unit 105 is transferred to and stored in a memory region (not shown) in information data management apparatus 100 other than data storage unit 105 or transferred to another apparatus differing from information data management apparatus 100 to be stored in a memory region of another apparatus.

In the present embodiment, data deletion is effected for each information data 3i or summary data 5i. Alternatively, only a portion of information data 3i can be deleted. Also, the amount of data to be deleted can be altered according to the determined level of importance.

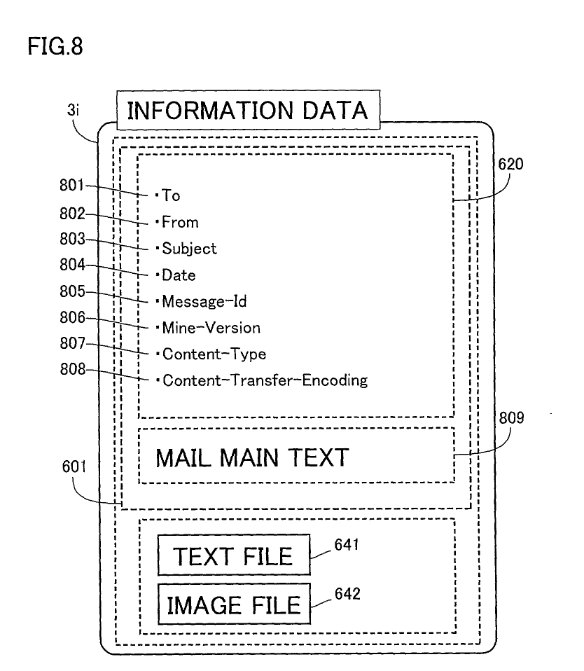

For example, an example of a data structure in the case where information data 3i is electronic mail data attached with a file is shown in FIG. 8. In FIG. 8, a header 620 including To field 801, From field 802, Subject field 803, Data field 804, Message-Id field 805, Mine-Version field 806, Content-Type field 807 and Content-Transfer-Encoding field 808, and mail main text 809 are included in mail body 601 of information data 3i in FIG. 8. A text file 641 and an image file 642 are attached to this electronic mail.

An approach can be taken in which, when the electronic mail of FIG. 8 is the subject of deletion in order to ensure an available capacity in data storage unit 105, the entire electronic mail of FIG. 8 is not deleted. At least one of attached text file 641 and image file 642 is deleted to leave mail main unit 601. As an alternative approach, deletion can be effected in a stepped manner to ensure an available capacity by first deleting one of the attached text file 641 and image file 642, and then deleting the other file when still an available capacity is not sufficient, and then further deleting mail main text 809 when still an available capacity cannot be achieved.

In the case where data compression is effected that will be described afterwards in order to ensure an empty region in data storage unit 105, data can be compressed in a stepped manner, similarly to the stepped deletion described above. Deletion and compression of such a stepped manner can be applied also to summary data 5i.

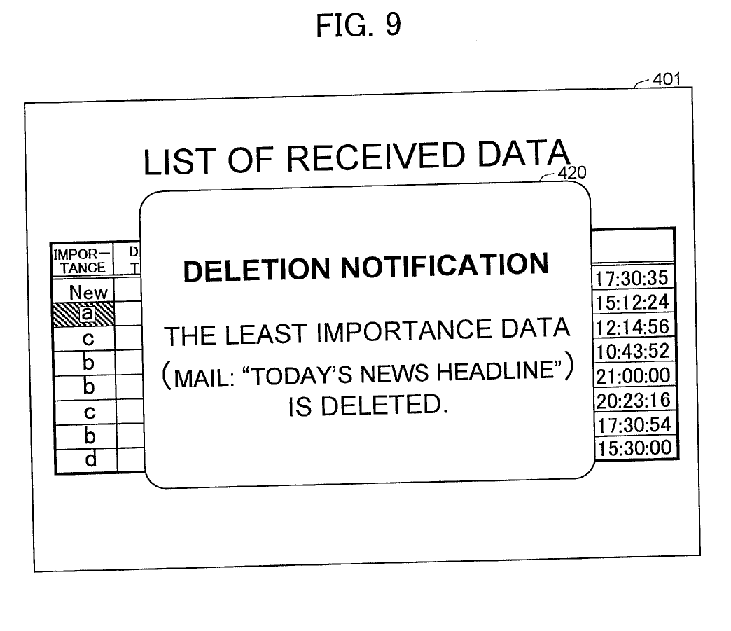

In the present invention, the user can be notified of data deletion, when executed. FIG. 9 shows an example of a screen displayed at the output unit of information processor 1 to notify the user that data deletion has been completed. In a screen 401 of FIG. 9, a window 420 appears in which a message is displayed notifying the user that data of the lowest level of importance has been deleted, identifying the deleted data.

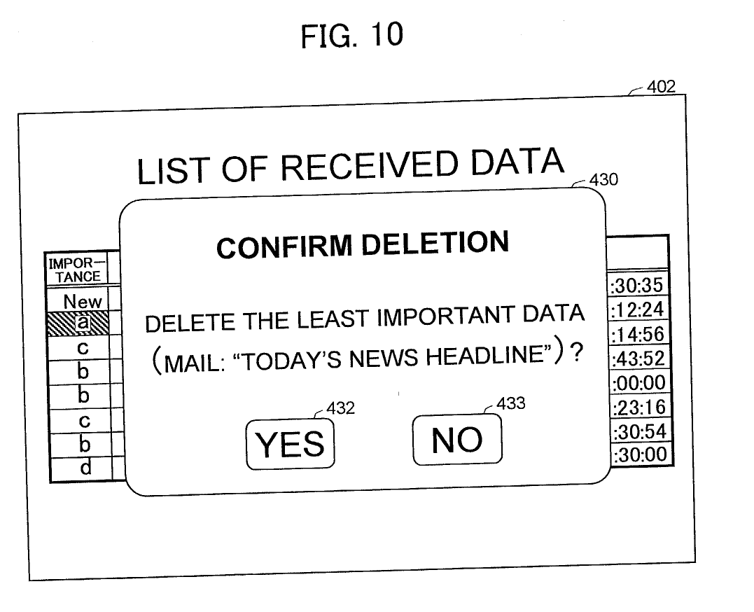

A screen 402 of FIG. 10 requesting the user to confirm deletion may be displayed at the output unit of information processor 1. In screen 402 of FIG. 10, a window 430 is displayed including a message asking whether deletion of the data of the lowest level of importance is permitted or not, identifying the relevant data, and buttons 432 and 433 to allow or not allow, respectively, deletion. The user can confirm the message displayed in window 430 and operate button 432 in the case deletion is allowed, whereby data is actually deleted. In the case where deletion of the relevant data is not desired and deletion is not permitted, button 433 is operated. Therefore, deletion of required data can be prevented.

In a similar manner for the data compression process carried out to ensure an available capacity in data storage unit 105, an approach can be taken to display a screen notifying the user that data has been compressed or a screen asking the user whether data compression is allowed or not.

In the present embodiment, determination of the level of importance is carried out when the available capacitance in data storage unit 105 is insufficient. However, the timing of determination is not limited thereto. For example, determination can be carried out at a constant cycle, or when the user operates the determination criterion of the importance level, or at an arbitrary time specified by the user.

Second Embodiment

A second embodiment will be described hereinafter. In contrast to the previous first embodiment in which an available capacity is ensured by deleting selected data from data storage unit 105, a process of compressing selected data is carried out together with such data deletion in the second embodiment.

The form of summary data 5i, the importance level determination method and data deletion method in the second embodiment are similar to those of the first embodiment. Therefore, illustration and description thereof will not be repeated.

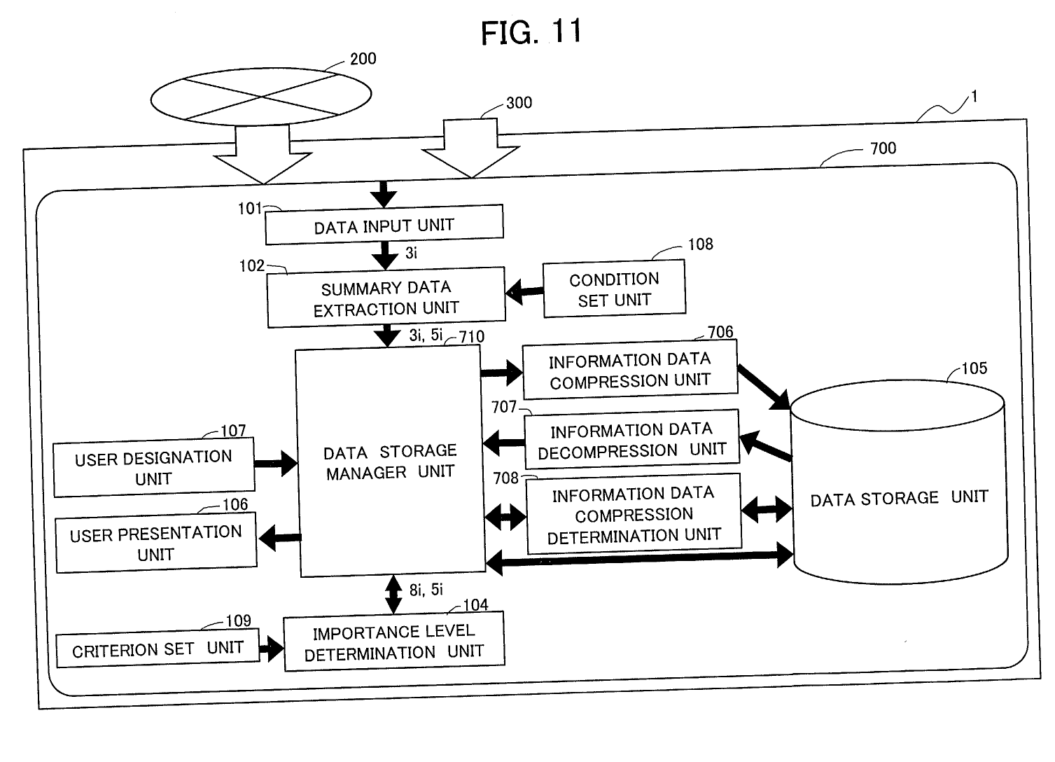

FIG. 11 shows a structure of an information data management apparatus 700 of the second embodiment. In FIG. 11, components corresponding to those of information data management apparatus 100 of the first embodiment have the same reference characters allotted, and description thereof will not be repeated.

Information data management apparatus 700 includes a data input unit 101, a summary data extraction unit 102, a data storage manager unit 710, an importance level determination unit 104, a data storage unit 105, a user presentation unit 106, a user designation unit 107, a condition set unit 108, a criterion set unit 109, an information data compression unit 706, an information data decompression unit 707, and an information data compression determination unit 708.

Information data compression unit 706 has a capability to compress information data 3i. Information data decompression unit 707 has a capability to decompress the compressed information data 3i. Information data compression determination unit 708 determines whether information data 3i in data storage unit 105 specified by data storage manager unit 710 is compressed or not. User designation unit 107 has a capability to accept a confirmation request of desired information data 3i from the user to instruct data storage manager unit 710 to confirm the relevant desired information data 3i.

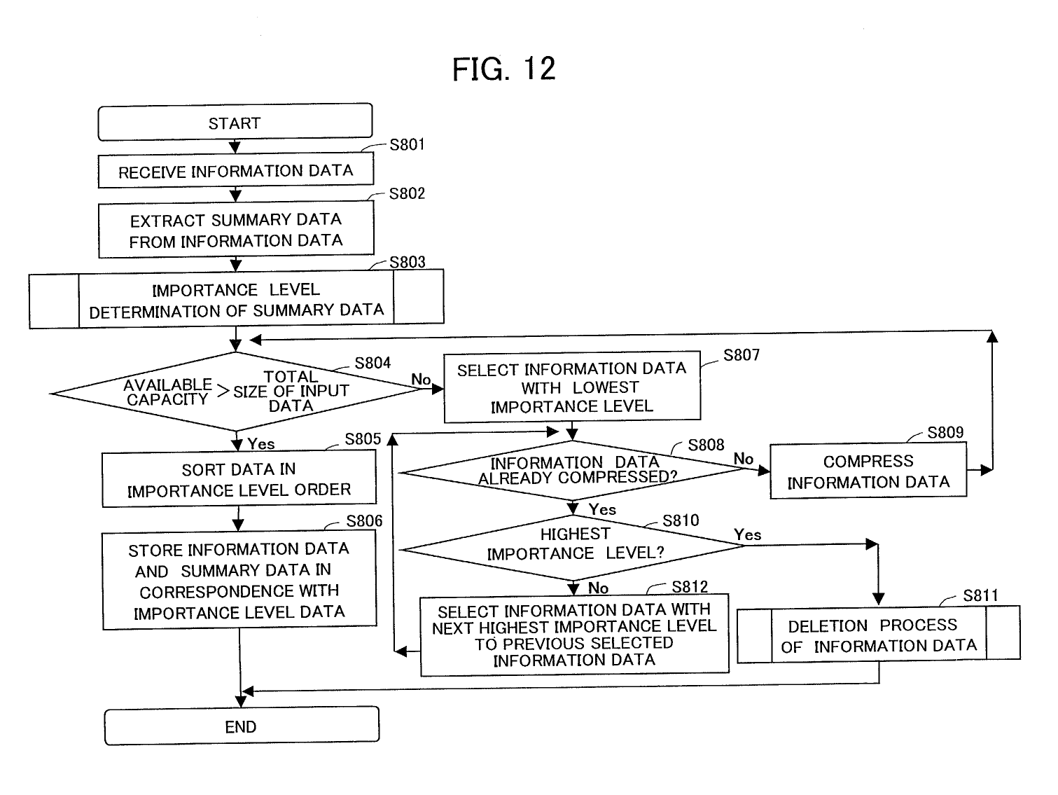

FIG. 12 is a flow chart of an information data acquisition process of the second embodiment. The process carried out after information data management apparatus 700 receives information data 3i via the Internet 200 or user input 300 will be described with reference to FIG. 12. The extraction feature of summary data 5i by summary data extraction 102 and the determination of importance level data 8i by importance level determination unit 104 are similar to those of the first embodiment. Therefore, description thereof will not be repeated. It is assumed that importance level data 8i is sorted and stored in the ascending order in data storage unit 105, and information data 3i and summary data 5i are stored in data storage unit 105 corresponding to the sorted importance level data 8i.

Externally applied information data 3i is input at data input unit 101, and output to summary data extraction unit 102 (S801). Upon entry of information data 3i at summary data extraction unit 102, summary data 5i is extracted from the input information data 3i (S802). The extracted summary data 5i and corresponding information data 3i are output to data storage manager unit 710. Data storage manager unit 710 receives information data 3i and summary data 5i, and outputs summary data 5i to importance level determination unit 104.

Importance level determination unit 104 receives summary data 5i and refers to flag data 7 in summary data 5i to determine importance level data 8i (S803), in a manner similar to that described before. As a result of the determination, importance level data 8i is output to data storage manager unit 710.

When determination is made that the total size of input information data 3i and corresponding summary data 5i is smaller than the available capacity in data storage unit 105 (YES in step S804), data storage manager unit 710 sorts the input importance level data 8i in an appropriate order among all importance level data 8i stored in data storage unit 105, and then stores the input information data 3i and summary data 5i in data storage unit 105 in correspondence with the sorted importance level data 8i (S805 and S806). Thus, the process ends.

When determination is made that the total size of input information data 3i and summary data 5i is larger than the available capacity in data storage unit 105 (NO at S804), information data 3i with the lowest value of corresponding importance level data 8i is selected from all the information data 3i stored in data storage unit 105 (S807). Determination is made whether selected information data 3i is already compressed or not by information data compression determination unit 708 (S808). When the determination result indicates that information data 3i is not compressed, the relevant information data 3i in data storage unit 105 is compressed by information data compression unit 706 (S809). Then, control returns to S804, and the subsequent process is repeated.

In the case where the relevant information data 3i is already compressed, determination is made whether the value of importance level data 8i corresponding to the selected information data 3i takes the highest value or not (S810). If determination is made that the value is not the highest, information data 3i corresponding to importance level 8i that takes the next highest value to importance level data 8i of the previous selected information data 3i is selected (S812). The process of S808 and et seq. is likewise carried out for selected information data 3i.

In the case where select information data 3i has the highest value of corresponding importance level data 8i, a deletion process of information data 3i is carried out (S811) as shown in the first embodiment since an available capacity that allows storage of input data could not be ensured in data storage unit 105 even if compression is repeated. Thus, an available capacity is provided.

According to the flow chart of FIG. 12, the compression process of information data 3i in data storage unit 105 is repeated until an available capacity that allows storage of the input data is ensured in data storage unit 105, or until all information data 3i in data storage unit 105 is compressed. In the case where the available capacity to allow storage cannot be ensured even if the compression process on information data 3i is executed, the deletion process of information data 3i as shown in the first embodiment is carried out to acquire an available capacity.

In the second embodiment, information data 3i is compressed. Alternatively, corresponding summary data 5i can be compressed instead of information data 3i. Further alternatively, both information data 3i and corresponding summary data 5i can be compressed. The designation for such compression can be input by the user through user designation unit 107. In all the cases where compressed data is specified and read out according to user designation unit 107 and presented to the user by user presentation unit 106, a decompression process is carried out by information data decompression unit 707.

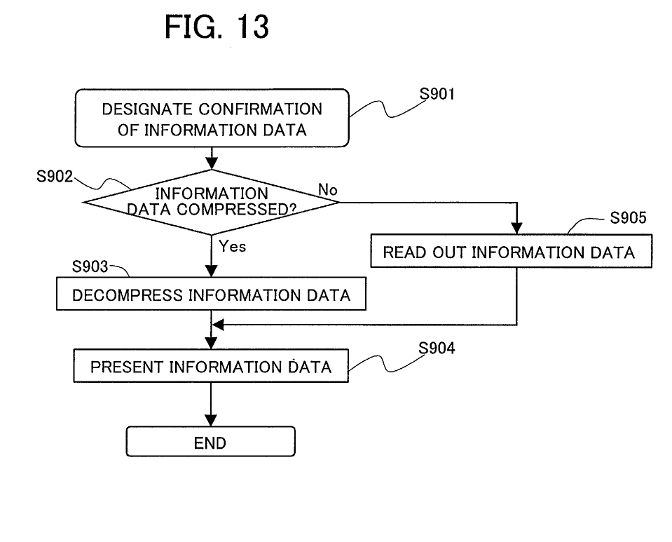

FIG. 13 is a flow chart of an information data confirmation process of the second embodiment.

When the user of information data management apparatus 700 specifies an appropriate information data 3i stored in data storage unit 105 and requests browsing of the desired information data 3i via user designation unit 107, user designation unit 107 receives and provides the relevant request to data storage manager unit 710 (S901).

In response to input of such a request, data storage manager unit 710 designates information data compression determination unit 708 to effect determination relating to compression of desired information data 3i. Information data compression determination unit 708 identifies the relevant information data 3i in data storage unit 105 and provides the determination result to data storage manager unit 710. Based on the input determination result, when determination is made that desired information data 3i is not compressed (NO at S902), the relevant information data 3i is read out from data storage unit 105 (S905). Then, control proceeds to S904 that will be described afterwards.

When determination is made that the desired information data 3i is compressed (YES at S902), data storage manager unit 710 outputs a decompression designation to information data decompression unit 707. Information data decompression unit 707 reads out the relevant information data 3i from data storage unit 105 and applies decompression thereon. The decompressed data is output to data storage manager unit 710 (S903).

Data storage manager unit 710 provides to user presentation unit 106 the input desired information data 3i read out from data storage unit 105. User presentation unit 106 receives and outputs desired information data 3i to present the relevant data to the user (S904).

By the above-described procedure, the contents of desired information data 3i can be perceived irrespective of whether the desired information data 3i is compressed or not.

Third Embodiment

A third embodiment of the present invention will be described here. In the third embodiment, a recording medium recorded with a program to execute the above-described process through a computer is shown.

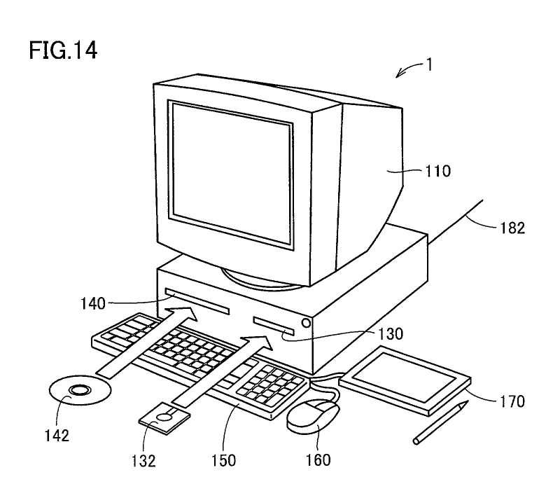

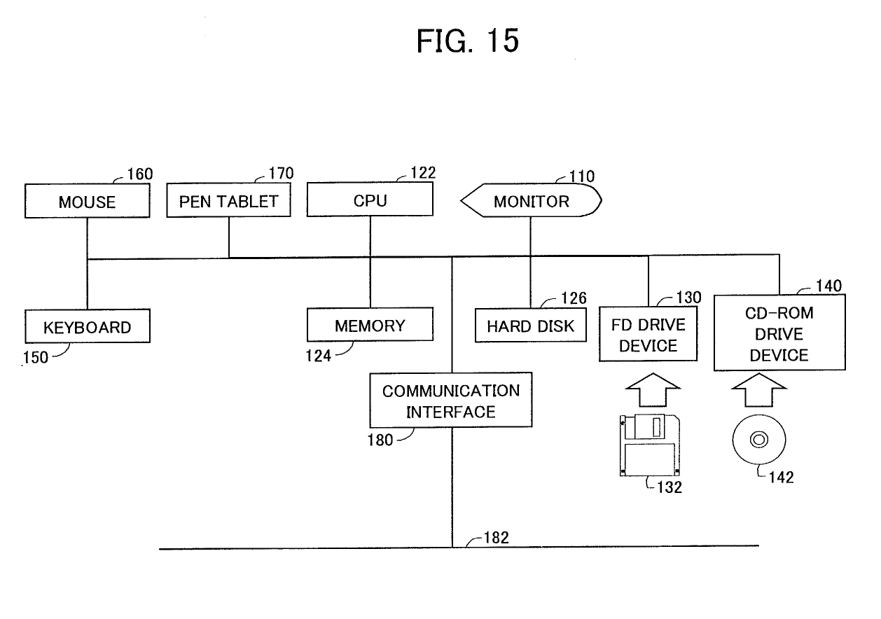

FIG. 14 is an appearance of an information processor 1 according to a third embodiment of the present invention. FIG. 15 shows the functional block of information processor 1 of FIG. 14. Information processor 1 incorporates the function according to the above-described information data management apparatus 100 or 700.

Referring to FIGS. 14 and 15, information processor 1 includes a monitor 110 of a CRT (Cathode Ray Tube) or liquid crystal, a keyboard 150, a mouse 160, a pen tablet 170, a CPU (Central Processing Unit) to control information processor 1 per se in a centralized manner, a memory 124 constituted by a ROM (Read Only Memory) or an RAM (Random Access Memory), a hard disc 126, a FD (Flexible Disc) drive device 130 mounted with a detachable FD 132 to access the mounted FD 132, a CD-ROM (Compact Disc Read Only Memory) drive device 140 mounted with a detachable CD-ROM to access the mounted CD-RAM 142, and a communication interface 180 to establish communication connection between a communication network 182 including the Internet 200 and information processor 1. Communication connection is established between each of these components via a bus.

A magnetic tape device having a detachable cassette type magnetic tape mounted to access the mounted magnetic tape can be provided in information processor 1.

Monitor 110 corresponds to user presentation unit 106. Keyboard 150, mouse 160 and pen tablet 170 correspond to user designation unit 107, condition set unit 108, and criterion set unit 109, respectively. User input through user designation unit 107, condition set unit 108 and criterion set unit 109 can be realized by specification of desired data through manipulation of the input unit by the user from the displayed data in monitor 110. Data storage unit 105 can be provided in memory 124, hard disc 126, or a FD 132 inserted in FD drive device 130.

As the recording medium of the third embodiment, the memory required to carry out the process in information processor 1 such as the ROM of memory 124 per se may be the program medium. Alternatively, the recording medium may be a program medium readable by insertion of a magnetic tape, FD 132 and CD-ROM 142 which are recording media where a program reader such as a magnetic tape device, a FD drive device 130 and CD-ROM drive device 140 not shown are provided as an external memory device. In all cases, the stored program may be of a structure that is accessed and executed by CPU 122. Alternatively, the program may be of the scheme that is temporarily read out and then loaded into a predetermined program area of information processor 1, for example the program storage area of RAM of memory 124, to be read and executed by CPU 122. It is assumed that the program for such loading is prestored in information processor 1.

The above-described program medium is a recording medium that is formed detachable from the body of information processor 1. It may be a medium that carries a program in a non-volatile manner. For example, it may be a tape system such as a magnetic tape or cassette tape, a disc system including a magnetic disc such as FD 132 and hard disc 126, or an optical disc such as CD-ROM 142/MO (Magnetic Optical Disc)/MD (Mini Disc)/DVD (Digital Versatile Disc), a card system such as an IC card including memory card/optical card, or a semiconductor memory formed of a mask ROM, EPROM (Erasable and Programmable ROM), EEPROM (Electrically EPROM), and flash ROM.

Since information processor 1 adapts a structure that allows communication connection with a communication network 182 including the Internet 200, a program can be down-loaded through communication network 182. In such a case, the program for down loading is prestored in the body of information processor 1, or installed into the body of information processor 1 from another recording medium.

The contents stored in the recording medium are not limited to a program, and may be data instead.

Although a desk top type computer as shown in FIG. 14 is exemplified as information processor 1 in the present embodiment, a portable computer such as a note type or lap top type computer or a mobile terminal can also be employed. Also, information processor 1 may be a terminal such as a cellular phone mainly based on a communication function rather than an information processing function.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information management apparatus applied to an information processor including a data storage unit in which various data are stored and an output unit to present information including contents stored in said data storage unit, said information management apparatus comprising:
information data input means for inputting information data,
summary data generation means for generating summary data that can indicate succinctly contents of said information data input through said information data input means; and
manager means for storing in said data storage unit said information data input through said information data input means and said summary data generated by said summary data generation means in correspondence,
wherein said manager means comprises
data reduction means for reducing a data amount of at least one of predetermined said information data and said summary data stored in correspondence in said data storage unit until a capacity available for storage is ensured when the capacity to store said information data newly input through said information data input means and corresponding said summary data is insufficient in said data storage unit,
said predetermined information data and summary data being selected according to a criterion set in a variable manner.

2. The information management apparatus according to claim 1, wherein said data reduction means reduces the data amount of at least one of said predetermined information data and summary data in a stepped manner.

3. The information management apparatus according to claim 1, wherein reduction of said data amount is effected by deleting at least one of said predetermined information data and summary data from said data storage unit.

4. The information management apparatus according to claim 1, wherein reduction of said data amount is effected by compressing at least one of said predetermined information data and summary data in said data storage unit.

5. The information management apparatus according to claim 4, wherein, when said available capacity for storage is still insufficient even after all said predetermined information data and summary data are compressed in said data storage unit, said manager means deletes at least 5 one of said predetermined information data and summary data stored in correspondence in said data storage unit until said available capacity for storage is ensured in said data storage unit.

6. The information management apparatus according to claim 5, wherein the data amount of at least one of said predetermined information data and summary data is deleted in a stepped manner until said available capacity for storage is ensured.

7. The information management apparatus according to claim 1, further comprising importance level determination means for determining a level of importance of said information data corresponding to said summary data based on a variably-set predetermined guideline,
said criterion corresponding to said level of importance determined by said importance level determination means.

8. The information management apparatus according to claim 7, further comprising guideline set means operated by an external source for setting said predetermined guideline in a variable manner.

9. The information management apparatus according to claim 7, wherein said level of importance corresponding to said predetermined information data and summary data is lower than said level of importance of said newly input information data.

10. The information management apparatus according to claim 1, wherein said manager means comprises insufficient capacity determination means for determining said insufficient capacity based on a comparison result by comparing an available capacity in said data storage unit and a total size of said information data newly input through said information data input means and corresponding said summary data.

11. The information management apparatus according to claim 1, wherein said summary data generation means generates said summary data based on data obtained according to a predetermined condition from contents of said information data, and wherein said predetermined condition is set in a variable manner.

12. The information management apparatus according to claim 11, further comprising condition set means operated by an external source for setting said predetermined condition in a variable manner.

13. An information management method comprising:
an information data input step of inputting information data, a summary data generation step of generating summary data that can indicate succinctly contents of said information data input at said information data input step, and
an organization step storing in correspondence said information data input at said information data input step and said summary data generated at said summary data generation step in a data storage unit prepared in advance from which stored contents are presented via an output unit prepared in advance,
wherein said organization step includes a data reduction step of reducing a data amount of at least one of predetermined said information data and said summary data stored in correspondence in said data storage unit until a capacity available for storage is ensured when the capacity to store said information data newly input at said information data input step and corresponding said summary data is insufficient in said data storage unit,
wherein said predetermined information data and summary data are selected according to a criterion set in a variable manner.

14. An information management method comprising:
an information data input step of inputting information data,
a summary data generation step of generating summary data that can indicate succinctly contents of said information data input at said information data input step, and
an organization step of storing in correspondence said information data input at said information data input step and said summary data generated at said summary data generation step in a data storage unit prepared in advance from which stored contents are presented via an output unit prepared in advance,
wherein said organization step comprises a compression step of compressing at least one of predetermined said information data and said summary data stored in correspondence in said data storage unit until an available capacity for storage is ensured when the capacity to store said information data newly input at said information data input step and corresponding said summary data is insufficient in said data storage unit,
wherein said predetermined information data and summary data are selected according to a criterion set in a variable manner.

15. A machine-readable recording medium recorded with an information management program to execute an information management method with the machine,
said information management method comprising:
an information data input step of inputting information data,
a summary data generation step of generating summary data that can indicate succinctly contents of said information data input at said information data input step, and
an organization step storing in correspondence said information data input at said information data input step and said summary data generated at said summary data generation step in a data storage unit prepared in advance from which stored contents are presented via an output unit prepared in advance,
wherein said organization step includes a data reduction step of reducing a data amount of at least one of predetermined said information data and said summary data stored in correspondence in said data storage unit until a capacity available for storage is ensured when the capacity to store said information data newly input at said information data input step and corresponding said summary data is insufficient in said data storage unit,
wherein said predetermined information data and summary data are selected according to a criterion set in a variable manner.

16. A program product to execute an information management method with a computer,
said information management method comprising:
an information data input step of inputting information data,
a summary data generation step of generating summary data that can indicate succinctly contents of said information data input at said information data input step, and
an organization step of storing in correspondence said information data input at said information data input step and said summary data generated at said summary data generation step in a data storage unit prepared in advance from which stored contents are presented via an output unit prepared in advance,
wherein said organization step comprises a data reduction step of reducing at least one of predetermined said information data and said summary data stored in correspondence in said data storage unit until an available capacity for storage is ensured when the capacity to store said information data newly input at said information data input step and corresponding said summary data is insufficient in said data storage unit,
wherein said predetermined information data and summary data are selected according to a criterion set in a variable manner.
